(19) United States
(12) Patent Application Publication
(10) Pub. No.: US 2003/0154290 A1
(43) Pub. Date: Aug. 14, 2003

(54) System and method for realtime-controlling web brower of user

(75) Inventors: Jee Hwan Moon, Daejeon (KR); Je Min Kook, Kyunggi-do (KR)

Correspondence Address: VOLPE AND KOENIG, P.C., UNITED PLAZA, SUITE 1600, 30 SOUTH 17TH STREET, PHILADELPHIA, PA, 19103, US

(73) Assignee: JEE HWAN MOON

(21) Appl. No.: 10/275,636

(22) PCT Filed: Mar. 7, 2002
(86) PCT No.: PCT/KR02/00389

(30) Foreign Application Priority Data
Mar. 9, 2001 (KR) 2001/12194

(51) Int. Cl. G06F 15/16

(52) U.S. Cl. 709/228

(57) ABSTRACT

A method and system for controlling in real-time a user browser is disclosed. The system includes a client-side script, a client role, a user browser, a server role, and a role support server. The method and system enables an administrator's of an HTML document including a client role, so that users can communicate with the administrator through their own browsers in real time using the client role and the administrator can remotely control remotely the user browser in real time using a server role. Therefor, users can communicate in real time with the administrator using the web browser without installation of any separate program, and perform a direct electronic messaging, confirmation of bilateral on/off-line, file transfer, etc.

### TECHNICAL FIELD

The present invention relates to a system and method for real-time control of web browsers of users, and more particularly, to a system and method for an administrator's registering of an HTML(Hyper Text Markup Language) document including a client role, so that users can communicate with the administrator through their own browsers in real time using the client role and the administrator can remotely control remotely the user browser in real time using an administrator program hereinafter referred to as a server role.

### BACKGROUND ART

With the advent of the World Wide Web, an ordinary person can easily utilize the Internet that had been monopolized by a few experts. The number of the web sites has been drastically increased in various fields due to the characteristics of the Internet, such as a mutual operation with users, direct marketing, nonrestriction of time,m abundant information, rapid updating of data, etc.

The World Wide Web is a storage that can search large-scaled information by on-line using an interactive application program called a browser. The browser displays the information on the web on a screen of a user computer, and the information displayed on the screen includes both texts and graphics.

FIG. 1 is a structural diagram explaining the concept of a conventional information exchange system 100 on the web. Referring to FIG. 1, the conventional information exchange system 100 includes a client 10, the Internet 20, an HTML document 40, a CGI(Common Gateway Interface) module 50, and a search engine 60. The client 10 means a browser such as Netscape or Explorer, which is installed in the user computers, and exchanges information such as URL or Multipurpose Internet Mail Extensions with the web server 30 via the Internet using the CGI. The web server 30 includes a server program, a processing program, and a database. The server program is a program for processing a search request for information having the form of URL, and the processing program is a program for supporting the mutual operation between the server and the client using CGI and ASP. The database stores the data. The web servers 30 are connected together via the Internet 20 for the exchange of their information.

The HTML document 40 is a document made by the HTML that is a language for drawing up a web page, and is comprised of a set of files which can include or connect almost all information provided by the computer, such as texts, graphics, sound, motion pictures, software, and application program.

The CGI module 50 performs the function of extending the HTML function by linking the web server 30 with an external application program. The web server 30 also connects with the search engine 60, and searches for information(or data) desired by the client 10 using the search engine 60. At this time, the search may include all effective use of the information through an analysis, induction, and conclusion using a result of search, as well as the search for the desired information.

When the client 10 requests a web server 30 a particular document using a HTTP(Hyper Text Transfer Protocol) message via the Internet 20, the web server 30 sends the corresponding HTML document to the client 10. Therefore, the client needs a particular program that is a browser 10 capable of reading the HTML document in order to use the information provided from the web. The client 10 and the web server 30 exchanges mutually the HTML document using the HTTP. The HTML document is displayed on the screen of the client browser. The HTML document may be drawn up using a general document editor or HTML editor, or be converted from a certain document.

Generally, to provide information from the web and vice versa, an administrator uploads the information to the web server, and a user requests and receives the information through the browser. That is, for the user to access a web site and to use information is no more than to read the information registered by the administrator.

That is the user can use only the document registered on the web server, and the administrator can not provide the user with the document in real time. Also, only limited kinds of documents can be provided on the web according to the performance of the web server.

Therefore, there has been a demand for a method and system for sending private requirements of users to the administrator, and then providing users with the information adapted to the respective users.

### DISCLOSURE OF INVENTION

Therefore, it is an object of the present invention to provide a method and system for real-time control of a user browser which forms a direct communication path between a user and an administrator by transmitting a HTML document including a specified program such as a client role.

It is another object of the present invention to provide a method and system for real-time control of a user browser which can provide a user with services immediately and actively in response to a user's request by forming a real-time communication path between the user and an administrator.

It is still another object of the present invention to provide a method and system for real-time control of a user browser which can modify or convert the HTML document displayed on the user browser in real time without an administrator's uploading of the HTML document to a web server.

In one aspect of the present invention, there is provided a system for controlling in real time a user browser using a particular function and exchanging information on the browser via a network. The system comprises a user browser, a server role, a role support server, and a database. The user browser, which performs an operation corresponding to the function from a client-side script, includes the client-side script for instructing a fulfillment of the browser operation according to a command corresponding to the function, and a client role for receiving and transmitting a control command from the outside to the client-side script, and transmitting an IP address of a corresponding computer and a predetermined administrator identification code. The server role, which is connected mutually with the user browser, selects the user browser to be controlled through a client role list, generating and transmitting the function so as to directly control the user browser in real time, and transmitting the information on its own computer. The role support server, which is connected with the client role of the user browser and the server role, supports server for receiving the IP address and the administrator identification code from the client role and server role, instructs to store the IP address in the corresponding memory, and supports an information exchange between the client role and the server role. The database, which is connected with the role support server, includes a role identification code representing the status of access of the client role and the server role, a client role address representing an IP address of the client role, and a server role address representing an IP address of the server role in order to extract and transmit the corresponding information according to a request from the role support server.

In another aspect of the present invention, there is provided a method for controlling a user browser using a particular function and exchanging information via a network, comprising the steps of:

(a) transmitting all administrator identification code subject to communication and computer information of a client role to a role support server;

(b) transmitting a registered administrator identification code, a password, and computer information of a server role to the role support server;

(c) transmitting a result of authentication performed based on the information transmitted at the steps (a) and (b) to the corresponding client role and the server role, and supporting mutual exchange of the information transmitted between the client role and the server role; and

(d) forming, a communication path between the client role and the server role to communicate mutually in accordance with the result of the authentication.

According to the present invention, the administrator transmits a HTML document including an application program, which is a client role, forming a communication path between the administrator and the user. Therefore, the user only sees the HTML document through the browser, thereby forming the communication path.

Accordingly, the user can communicate directly with an administrator in real time without installing a particular program for communicating with an administrator. Additionally, the user can confirm bilaterally the status of on/off line, exchange bilaterally a message, and transfer a file. And, the client role can handle the client-side script to manipulate and modify the web page displayed on the user browser, so that the administrator can control all of the function of the user browser using the client role, and display directly the information on the screen of the user computer without uploading to the web server. Therefore, the administrator can provide immediately users with the active service and the information in response to the user's request. The client role is a program operating in the browser, and is drawn up using Java, Shockwave, or Active-X which are able to execute in the browser. According to the present invention, the administrator program including a server role may be a form of the independent program, which is installed in the administrator computer for the convenience of authentication and use. The administrator program may be also used the web browser of another computers without installation of an independent programs. In this case, the authentication about the administrator is fulfilled using the web server. The server role can control the client-side script through the client role, and the client-side script can control the server-side script. That is, the administrator can control remotely the information registered on the web server using the client role.

### BRIEF DESCRIPTION OF THE DRAWINGS

FIG. 1 is a structural diagram explaining a conventional information exchange system based on a web.

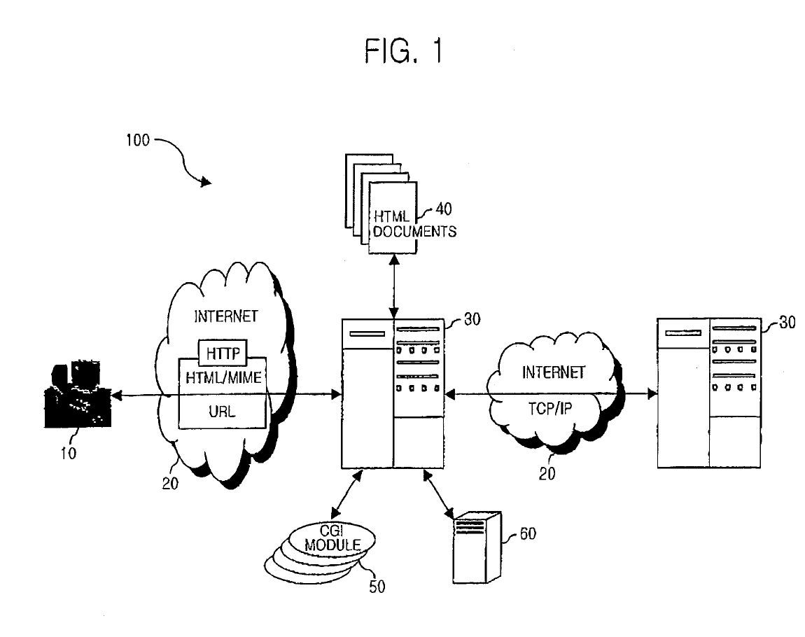

FIG. 2 is a block diagram showing a network structure in accordance to the present invention.

FIG. 3 is a block diagram showing an internal structure of the real-time control system according to the present invention.

FIG. 4 is a flowchart showing the communication process between a client role and a role support server.

FIG. 5 is a flowchart showing the communication process between a server role and a role support server.

FIG. 6 is a flowchart showing the communication process between a client role and a server role.

### BEST MODE FOR CARRYING OUT THE INVENTION

Hereinafter, a detailed description will be provided about the preferable embodiments according to the present invention with reference to accompanying drawings.

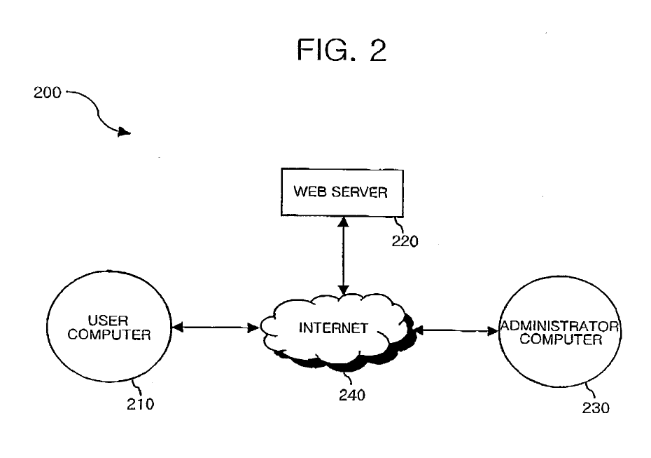

FIG. 2 is a block diagram showing the network structure according to the present invention. As shown in FIG. 2, the network 200 is comprised of a user computer 210, a web server 220, and an administrator computer 230, and the components are connecting via the Internet 240.

The user computer 210 accesses to the web server 220 via the Internet 240 and receives an HTML document including a client role through a web browser of the user computer 210. By using the client role of the HTML document, the administrator computer 230 can directly control the HTML document displayed on the web browser of the user computer 210 in real time. The administrator computer 230 can also transmit all kinds of communicable information as well as control commands to the user computer 210 through the server role, and the user computer 210 can transmit information to the administrator computer 230 through the client role. The present invention described the network 200 which includes the web server 220. However, the network according to the present invention can be accomplished without the web server. The system according to the present invention includes the web server 220 so as to represent that the system can employ the structure of conventional network. However, when the system should be organized to perform the function of the web server by the administrator, the user computer 210 and the administrator computer 230 of the system can mutually communicate through their communication path without the web server server.

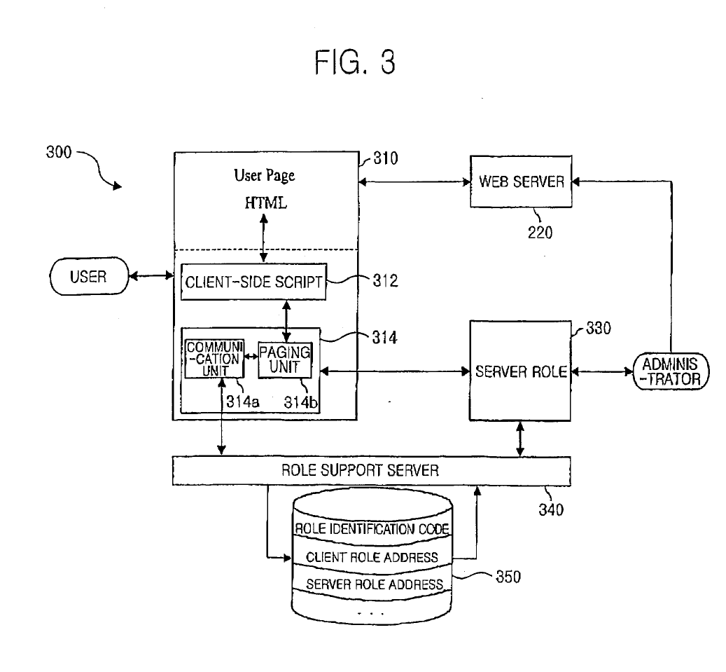

FIG. 3 is a block diagram showing the internal structure of the real-time control system 300 according to the present invention. As shown in FIG. 3, the real-time control system includes a user browser 310, a web server 220, a server role 330, a role support server 340, and a database 350, and the user browser 310 includes a client-side script 312 and a client role 314.

The user browser 310, an application program which is installed and executed on the user computer, allows the user to access to all the information provided from the Web. The user browser 310, which is used for search for information on the web on the Internet, fulfills functions of browser, electronic mail, Internet application program, multimedia support, security, expansion, and so on. The user browser 310, which is a software based on the Window, can search the documents and the multimedia information such as an image file, a sound file, and a motion pictures file, on the Internet. It can also search the documents provided by a HTTP server, a FTP server, a GOPHER server, an WAIS server, etc.

The user browser 310 includes a client-side script 312 and a client role 314. The client-side script 312 is a script which is executed on the web browser of the client computer, and may be one of Java Script, VB Script, J Script, and so on. The client-side script 312 can make the interface of a web page dynamically, and also make a mutually operative document which is communicative with the user only by the click.

Exchange of the information on the Web is fulfilled by the Client-Pull method which a server transmits a source code to a client and the client interprets and executes the source code.

The client-side script 312 is a language for developing dynamic web documents to overcome the limits of the HTML. Because of executing by an interpreter of the browser, the client-side script 312 can be developed without preparation of installing specific programs if the browser exists. That is, the client-side script 312 serves as a means for operating the browser according to the operation commands corresponding to the applied function.

The client role 314 interconnects with the client-side script 312, and includes a communication unit 314a receiving the function from the server role 330, and a paging unit 314b executing the function and transmitting the parameters of the function to the client-side script.

The communication unit 314a receives a function from the server role 330 and transmits the function to the paging unit 314b, and the paging unit 314b performs the function and transmits the parameters of the function to the client-side script such as Java script. As the user executes the user browser, the client role 314 transmits an IF address of the corresponding computer and an administrator identification code to the role support server 340 through the communication unit 314a, receives the IP address of the server role 330 and transmits the desired information in the form of a file or a message to the server role 330.

The server role 330, which is an administrator program executed by the administrator, generates a specified function and transmits it to the client role 314 of the desired user browser 310 in order to control directly the browser 310 in real time. The server role 330 can be embodied through an independent program which is installed and executed in the administrator computer for the convenience of authentication and use. The server role 330 can be also embodied through a web server 220 so that the user can implement it using the browser of another computers except for the user's computer without installation of the independent program. To control the user browser using the server role 330, the administrator has to search for the corresponding user browser through the client role list, select the user browser, and thus input a specific function to fulfill the desired operation. When the administrator controls the user browser 310, the inputted function in the server role 330 must be same as a function fulfilled in the client-side script 312.

The role support server 340, which is positioned between the client role 314 and the server role 330, receives the IP addresses of corresponding computers from the client role 314 and the server role 330, and the administrator identification code from the client role 314 Also, the role support server 340 stores the received IP addresses in a predetermined space of the memory with reference to the administrator identification code. The role support server also transmits the information on the existence of the administrator identification code and the corresponding server role 330, and the IP address of the server role to the client role. The role support server 340 transmits information on the client roles 314 which are connected with a specific server role 330. The role support server 340 is connected with a database 350, which stores a role identification code representing the current access status of the client role and the server role, and client role address and server role addresses representing the IP addresses of the corresponding client role 314 and the server role 330, respectively.

The Web server 220 receives the HTML document including the administrator identification code from the administrator, and transmits the client role and the HTML document to the user browser 310 and simultaneously executes the client role 314 in the user browser 310. As described above, because the web server 220 is used to utilize the conventional network, the server role according to the present invention can perform the function of the web server. The present invention can also embodied by adding the client role and the HTML document including an administrator identification code to the web server 220.

Hereinafter, the operation of the system and method according to the present invention is described specifically in reference to the accompanying drawings.

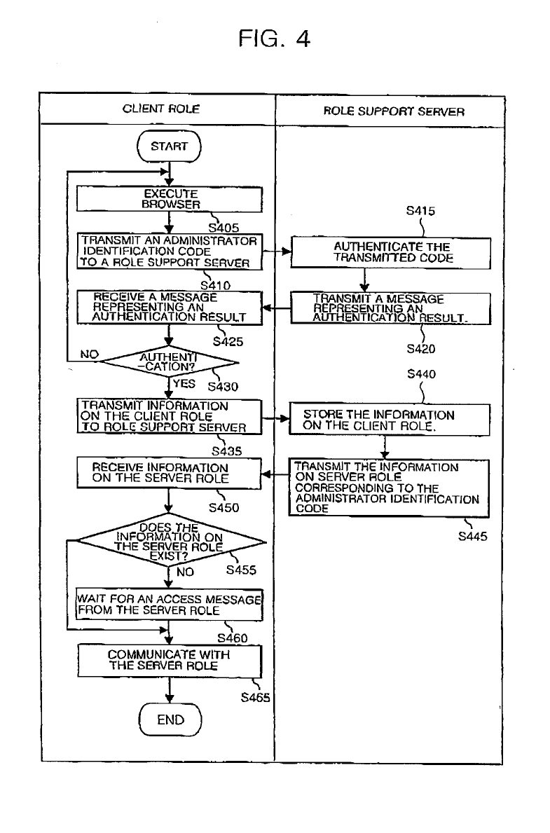

FIG. 4 is a flowchart showing the communication process between the client role and the role support server.

As shown in FIG. 4, the user receives the HTML document including the client role through the web server or the server role, and executes the browser(in step 405). Simultaneously with the execution of the user browser, the client role executes. The client role transmits the administrator identification code corresponding to the administrator with whom the user wants to communicate to the role support server via the communication unit(in step 410). The role support server searches the database for the administrator identification code, and authenticates the corresponding administrator if the administrator identification code exists(in step 415). The administrator identification code is stored in the role identification code of the database, and the database extracts the corresponding information that is the administrator identification code, and transmits it to the role support server according to the command of the role support server. The role support server receives the information on the corresponding administrator identification code from the database, and transmits a message representing the result of authentication to the client role(in step 420). The client role receives the message(in step 425), and discriminated whether to authenticate(in step 430). If the authentication is failed, it requests the reexecution of the user browser(in step 405), and if not, it transmits the information including the its own IP address to the role support server(in step 435). The role support server receives the IP address of the client role, stores it in the memory of which the address relates with the administrator identification code(in step 440), transmits the information on the corresponding server role of the administrator identification code requested from the user to the client role(in step 445), and then stops communicating with client role. That is, the role support server authenticates the administrator identification code from the client role and transmits the information on the server role corresponding to the administrator identification code, and completes its task. The client role receives the information on the server role from the role support server (in step 450) to confirm the status of the access and an IP address of the server role using the information. Then, the client role determines the status of the server role using the information transmitted from the role support server(in step 455). If the server role is not connected, the client role waits for the message representing the access from the server role(in step 460), and then communicates with the server role simultaneously with receiving the message from the server role(in step 465). In the step 455, if the server role is connected, the client role communicates with the corresponding server role using the information including the IP address of the server role, and then completes the process.

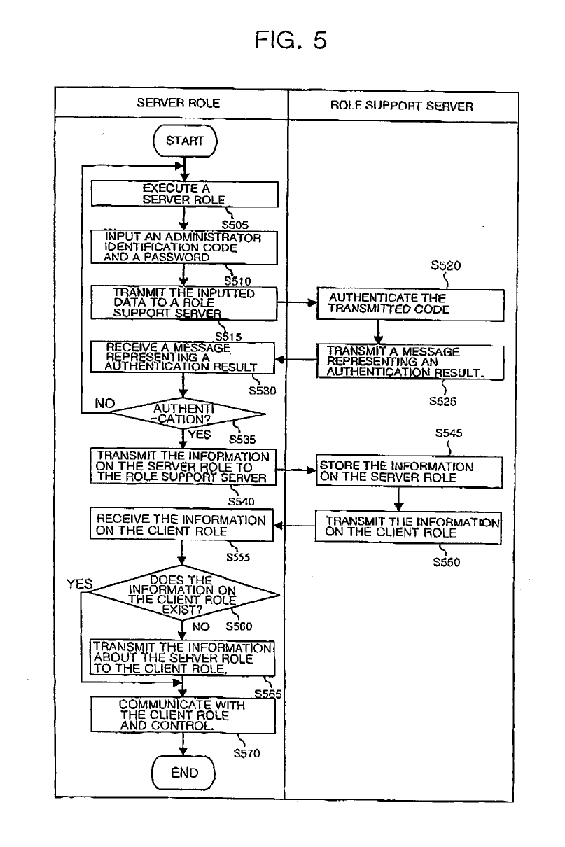

FIG. 5 is a flowchart showing the communication process between the server role and the role support server.

The administrator executes the server role(in step 505). The administrator inputs the administrator identification code and the authentication password to the server role(in step 510), and transmits the inputted information to the role support server(in step 515). The role support server searches for the administrator identification code and the authentication password in the database, and authenticates the administrator identification code(in step 520). The administrator identification code and the authentication password are stored in the role identification code of the database, which extracts the corresponding information, namely, the administrator identification code and the authentication password according to the command of the role support server and transmits the information to the role support server. The role support server receives the corresponding administrator identification code from the database, and transmits the message representing the result of the authentication to client role(in step 525). The server role receives the corresponding message(in step 530), and discriminates whether it is authenticated or not(in step 535). If the authentication is failed, the server role proceeds to the step 505, and requests the administrator for input of the administrator identification code and the authentication password. If the authentication is successful, the server role transmits the information including its own IP address to the role support server(in step 540). The role support server receives the IP address of the server role and stores the IP address into the memory related to the corresponding administrator identification code(in step 545), and transmits the information on the client role to the server role(in step 550), and stops communicating with the server role. That is, the role support server authenticates the administrator identification code transmitted from the client role, transmits the information on the server role corresponding to the administrator identification code, and then completes its task. The client role receives the information on the server role from the role support server(in step 555), and confirms the access status of the client role and the IP address of the client role using the information.

Next, the server role reads the information on the client role(in step 560). If the client role is not connected, the server role waits an access of a new client role. The server role transmits the information on the server role to a new client role in response to the access of the new client(in step 565), and communicates with the new client role to control a browser corresponding to the new client role(in step 570). If the client role is connected, the server role communicates with the corresponding client role using the information including an IP address of the client role, and terminates the process.

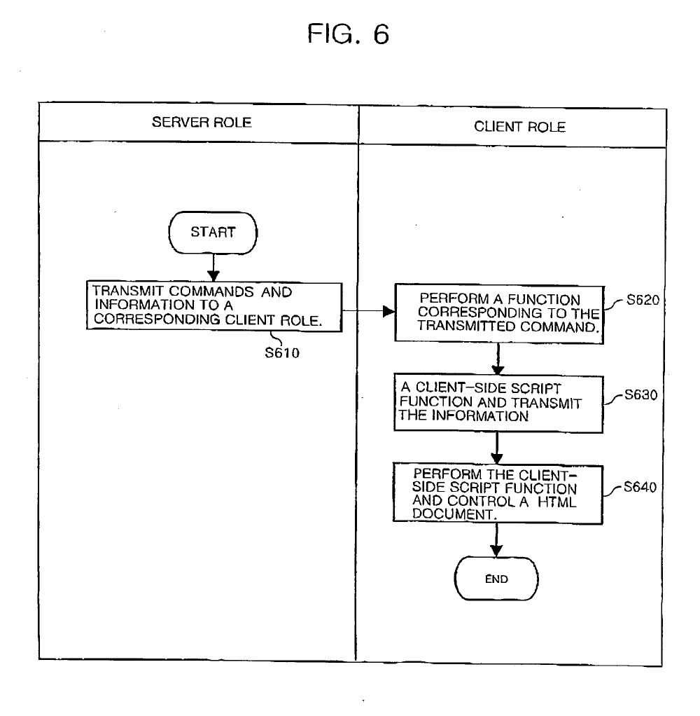

FIG. 6 is a flowchart showing the communication between the client role and the server role. On the assumption that there is a connection between the client role and the server role, and the administrator performs the operation that controls and converts the user browser into a predetermined URL such as “http://www.mtdot.com”.

The administrator executes the server role and inputs the corresponding string of the command such as http://www.mtdot.com through the input section of the server role. The server role fulfills the command that searches for the client list in the information on the client role transmitted from the role support server and transmits the message to the client role trying to control. At this time, the server role selects a desired client role front the client role list, and transmits the control command including the string inputted from the administrator to the client role(in step 610).

The control command from the server role is inputted through the communication unit of the client role, and the communication unit fulfills the function of the internal client role and transmits the corresponding control command to the paging unit(in step 620).

The paging unit calls the client-side script function using the internal function and transmits the corresponding control command(in step 630). That is, the paging unit provides a function) loaded in the internal client role such as “getMsgFromRole(msg)” with a parameter such as “http://mtdot.com” and then transmits the function getMsgFromRole(“http://wvw.mtdot.com”), which pages the client-side script. The client-side script performs the corresponding function to control the HTML document of the user browser(in step 640).

For example, the client-side script controls and converts the URL of the user browser into http://www.mtdot.com. It is natural that the user browser can be controlled unresrictedly according to a kind of the function controlling the HTML document of the user browser.

As described above, the user browser can be controlled in real-time according to the present invention so that the present invention can be applied in the various fields such as an Internet lecture system for the plurality of students, a data exchange for peer-to-peer, an Internet broadcasting system, and so on.

It should be understood that the present invention is not limited to the particular embodiment disclosed herein as the best mode contemplated for carrying out the present invention. It is intended to cover various modifications and similar arrangements included within the spirit and scope of the appended claims. Also, it is intended that the scope of the present invention be defined by the following claims and their equivalents.

Industrial Applicability

As described above, the system and method for controlling in real time a user browser according to the present invention allows the administrator and the user to communicate together using the HTML document including the client role. Therefore, the user can communicates in real time with the administrator through the web browser without installation of a special program, so that the user can send a message directly, confirm bilaterally, transfer a file, and so on.

Additionally, the system according to the present invention can be applied to the conventional network, without an alteration of the network, so as to cut down the cost of installation and additional up-grading of the system due to increase of the number of the users.

The administrator can also provide the user with all kinds of information such as image, file, and program, and control and modify remotely the user browser in real time using the client role because the client role can directly control the client-side script. Therefore, the administrator can fulfill a task in company with the user using the system according to the present invention.

1. A system for controlling in real time a user browser using a particular function and exchanging information on the browser via a network, comprising:
a user browser including a client-side script for instructing a fulfillment of the browser operation according to a command corresponding to the function, and a client role for receiving and transmitting a control command from the outside to the client-side script, and transmitting an IP address of a corresponding computer and a predetermined administrator identification code, the user browser performing an operation corresponding to the function from the client-side script;
a server role, connected mutually with the user browser, for selecting the user browser to be controlled through a client role list, generating and transmitting the function so as to directly control the user browser in real time, and transmitting information on its own computer;
a role support server, connected with the client role of the user browser and the server role, for receiving the IP address and the administrator identification code from the client role and the server role, instructing to store the IP address in a corresponding memory, and supporting an information exchange between the client role and the server role; and
a database connected with the role support server and including a role identification code representing a status of access of the client role and the server role, a client role address representing an IP address of the client role, and a server role address representing an IP address of the server role, the database extracting and transmitting the corresponding information according to a request from the role support server.

2. The system according to claim 1, further comprising a web server for transmitting a HTML document including the client role and the administrator identification code transmitted from the server role to the user browser, and instructing to execute the client role

3. The system according to claim 1, wherein the client role comprises:
a communication unit for receiving the function applied from the server role, transferring the user's request to the server role, transmitting the information on the computer corresponding to the user browser, and receiving the information on the server role from the role support server; and
a paging unit for performing the function applied from the communication unit, and transmitting parameters of the function to the client-side script.

4. A method of controlling a user browser using a particular function and exchanging information via a network, comprising the steps of:
(a) transmitting an administrator identification code subject to communication and information on a computer of the client role to a role support server;
(b) transmitting a registered administrator identification code, a password, and information on a computer of a server role to the role support server;
(c) transmitting a result of authentication performed based on the information transmitted at the steps (a) and (b) to the corresponding client role and the server role, and supporting mutual exchange of the information transmitted between the client role and the server role; and
(d) forming a communication path between the client role and the server role to communicate mutually in accordance with responsive to the result of authentication.

5. The method according to the claim 4, wherein the step (a) comprises the steps of:
(a1) executing the user browser and transmitting the administrator identification code subject to communication to the role support server;
(a2) transmitting a message representing the result of authentication with reference to the administrator identification code to the client role;
(a3) transmitting information including an IP address of the client role to role support server in accordance with the result of the authentication; and
(a4) transmitting the information on the server role corresponding to the administrator identification code, and forming the communication path between the client role and the server role if the information on the server role exists.

6. The method according to claim 4, wherein the step (b) comprises the steps of:
(b1) executing the server role, and transmitting the its own administrator identification code and the password to the role support server;
(b2) authenticating the administrator identification code and the password, and transmitting a message representing a result of the authentication to the server role;
(b3) transmitting the information including an IF address of the server role to the role support server if the administrator identification code and the password are authenticated; and
(b4) transmitting the information on the client role corresponding to the administrator identification code and forming a communication path between the client role and the server role if the information on client role exists.

7. The method according to claim 4, wherein the step (d) comprises the steps of:
(d1) executing the server role in order to input a string corresponding to a command, search a client role list for a client role to be controlled, and transmit a message to the searched client role;
(d2) receiving a control command from the server role through a communication unit, and executing an internal function of the client role by the communication unit to transmit the corresponding control command to a paging unit;
(d3) paging an internal function of a client-side script and transmitting the control command corresponding to the function; and
(d4) controlling a HTML document of the user browser to perform an operation corresponding to the function.
